(19) United States
(12) Patent Application Publication
(10) Pub. No.: US 2016/0006846 A1
(43) Pub. Date: Jan. 7, 2016

(54) MOBILE COMMUNICATION TERMINAL

(71) Applicant: Alibaba Group Holding Limited, Grand Cayman (KY)

(72) Inventors: Kai Xu, Shanghai (CN); Jianjun Fan, Shanghai (CN)

(21) Appl. No.: 14/789,631

(22) Filed: Jul. 1, 2015

(30) Foreign Application Priority Data
Jul. 4, 2014 (CN) 201420372167.6

(51) Int. Cl. H04M 1/02; H04R 25/00

(52) U.S. Cl. CPC H04M 1/0266; H04R 25/606

(57) ABSTRACT

A mobile communication terminal, which includes a front panel, a bone conduction device and a motherboard is disclosed. The front panel is configured with a screen. The bone conduction device is in contact with the screen or the front panel, and a contact point of the bone conduction device is connected with the motherboard. The bone conduction device receives an electronic signal transmitted from a processor of the motherboard through the contact point, and transmits the electronic signal to the screen or the front panel through a place of contact therebetween to activate vibrations of the screen or the front panel, thereby transmitting audio to a user. Since the bone conduction device is used in the present disclosure to replace a receiver for transmitting electronic signals, audio can be transmitted to the user through the bone conduction device in a normal manner regardless of whether the mobile communication terminal is in a status of an upright position or in a status of an inverted position. Therefore, the user can hear the voice of another party clearly, and thus the quality of conversation is improved.

### CROSS REFERENCE TO RELATED PATENT APPLICATION

This application claims foreign priority to Chinese Patent Application No. 201420372167.6 filed on Jul. 4, 2014, entitled “Mobile Communication Terminal”, which is hereby incorporated by reference in its entirety.

### TECHNICAL FIELD

The present disclosure relates to the field of communication technologies, and in particular, to mobile communication terminals.

### BACKGROUND

When conducting a call, a traditional mobile communication terminal (such as a mobile phone) converts an electronic signal into an audio signal and transmits the audio signal to a human ear through a receiver, thereby enabling a user to hear a voice of another party. When a mobile communication terminal is designed, the number of front sound holes of a receiver needs to be increased to allow successful transmission of an audio signal to a human ear through the front sound holes of the receiver. The front sound holes of the receiver are generally holes that are opened at the top part of a front panel of the mobile communication terminal, with a structure thereof corresponding to a design of a front sound cavity. Therefore, when listening to a phone, a user needs to align his/her ear directly with front sound holes of a receiver in order to hear a voice of another party clearly.

Along with the increasing popularity of smartphones, the size of a display of a mobile communication terminal has become larger, and an area of the display almost occupies the entire area of a front surface of the mobile communication terminal. A user may sometimes find it difficult to distinguish between a top portion and a bottom portion of a front panel of the mobile communication terminal, especially when the color thereof is black. Therefore, when answering a phone, the user may hold the mobile communication terminal in a reverse orientation. Under such circumstances, front sound holes of a receiver of the mobile communication terminal may not be aligned with an ear of the user correctly, leading to a failure of transmitting sound from the front sound holes of the receiver to the ear. As such, the user will fail to hear the voice of another party clearly, resulting in a poor quality of conversation.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

The present disclosure provides a mobile communication terminal to solve the problems in existing technologies relating to sound failing to be transmitted from front sound holes of a receiver to an ear and causing the user to fail to hear the voice of another party clearly when a mobile communication terminal is held in a reverse orientation and the front sound holes of the receiver of the mobile communication terminal are not aligned correctly with the ear of the user, which results in a poor conversation quality.

The present disclosure provides a mobile communication terminal, which includes: a front panel, a bone conduction device and a motherboard. The front panel is configured with a screen. The bone conduction device is in contact with the screen or the front panel, and a contact point of the bone conduction device is connected to the motherboard. The bone conduction device receives an electronic signal transmitted from a processor of the motherboard through the contact point, and transmits the electronic signal to the screen or the front panel through a place of contact therebetween to activate vibrations of the screen or the front panel.

In an embodiment, the mobile communication terminal may further include a gravity sensor, a first sound transmitter and a second sound transmitter. The gravity sensor is deployed in the motherboard, and is used for detecting a placement status of the mobile communication terminal. The first sound transmitter is deployed at the top of the front panel and is connected with the motherboard. The second first sound transmitter is deployed at the bottom of the front panel and is connected with the motherboard.

The processor of the motherboard sets up respective working states of the first sound transmitter and the second sound transmitter based at least in part on the placement status detected by the gravity sensor. In an embodiment, in an event that the mobile communication terminal is in a status of an upright position, the processor transmits a first control signal to the second sound transmitter and a second control signal to the first sound transmitter. In another embodiment, in an event that the mobile communication terminal is in a status of an inverted position, the processor transmits the first control signal to the first sound transmitter and the second control signal to the second sound transmitter. The first control signal is used for setting up a sound transmitter in a working state for transmission of an audio signal, and the second control signal is used for setting up a sound transmitter in a working state for noise cancellation.

In an embodiment, the mobile communication terminal may further include a receiver and a gravity sensor. The receiver is deployed at the top of the front panel, and is connected with the processor of the motherboard via a first interface. The bone conduction device is deployed at the bottom of the screen or the front panel, and is connected with the processor of the motherboard via a second interface. The gravity sensor is used for detecting a placement status of the mobile communication terminal.

In an embodiment, the processor transmits an electronic signal to the receiver or the bone conduction device based at least in part on the placement status detected by the gravity sensor. In an embodiment, in an event that the mobile communication terminal is in a status of an upright position, the processor transmits the electronic signal to the receiver via the first interface. In another embodiment, in an event that the mobile communication terminal is in a status of an inverted position, the processor transmits the electronic signal to the bone conduction device via the second interface.

Additionally, in an embodiment, the mobile communication terminal may further include a first sound transmitter and a second transmitter. The first sound transmitter is deployed at the top portion of the front panel and is connected with the motherboard. The second first sound transmitter is deployed at the bottom portion of the front panel and is connected with the motherboard.

The processor of the motherboard sets up respective working states of the first sound transmitter and the second sound transmitter based at least in part on the placement status detected by the gravity sensor. In an embodiment, in an event that the mobile communication terminal is in a status of an upright position, the processor transmits a first control signal to the second sound transmitter and a second control signal to the first sound transmitter. In another embodiment, in an event that the mobile communication terminal is in a status of an inverted position, the processor transmits the first control signal to the first sound transmitter and the second control signal to the second sound transmitter. The first control signal is used for setting up a sound transmitter in a working state for transmission of an audio signal, and the second control signal is used for setting up a sound transmitter in a working state for noise cancellation.

In an embodiment, the bone conduction device is attached to an internal surface of the screen.

In an embodiment, the bone conduction device may be a bone conduction ceramic device.

The present disclosure provides a mobile communication terminal, which includes: a front panel, a bone conduction device and a motherboard. The front panel is configured with a screen. The bone conduction device is in contact with the screen or the front panel, and a contact point of the bone conduction device is connected with the motherboard. The bone conduction device receives an electronic signal transmitted from a processor of the motherboard through the contact point, and transmits the electronic signal to the screen or the front panel through a place of contact therebetween to activate vibrations of the screen or the front panel, thereby transmitting audio to a user. Since the bone conduction device is used in the present disclosure to replace a receiver for transmitting electronic signals, audio can be transmitted to the user through the bone conduction device in a normal manner regardless of whether the mobile communication terminal is in a status of an upright position or in a status of an inverted position. Therefore, the user can hear the voice of another party clearly, and thus the quality of conversation is improved.

### BRIEF DESCRIPTION OF THE DRAWINGS

FIG. 1 is a schematic diagram illustrating a mobile communication terminal in accordance with a first embodiment of the present disclosure.

FIG. 2 is a schematic diagram illustrating a bone conduction device in accordance with the present disclosure.

FIG. 3 is a schematic diagram illustrating a mobile communication terminal in accordance with a second embodiment of the present disclosure.

FIG. 4 is a schematic diagram illustrating a mobile communication terminal in accordance with a third embodiment of the present disclosure.

FIG. 5 is a schematic diagram illustrating a mobile communication terminal in accordance with a fourth embodiment of the present disclosure.

FIG. 6 is a schematic diagram illustrating the example mobile communication terminal as shown in FIGS. 1 and 3-5 in more detail.

### DETAILED DESCRIPTION

The present disclosure provides a mobile communication terminal which includes a front panel, a bone conduction device and a motherboard. By using the bone conduction device to replace a receiver for transmitting electronic signals, the mobile communication terminal can transmit audio to a user through the bone conduction device in a normal manner, and thus enable the user to clearly hear the voice of another party.

The present disclosure is described herein in further detail with reference to drawings accompanying with the specification.

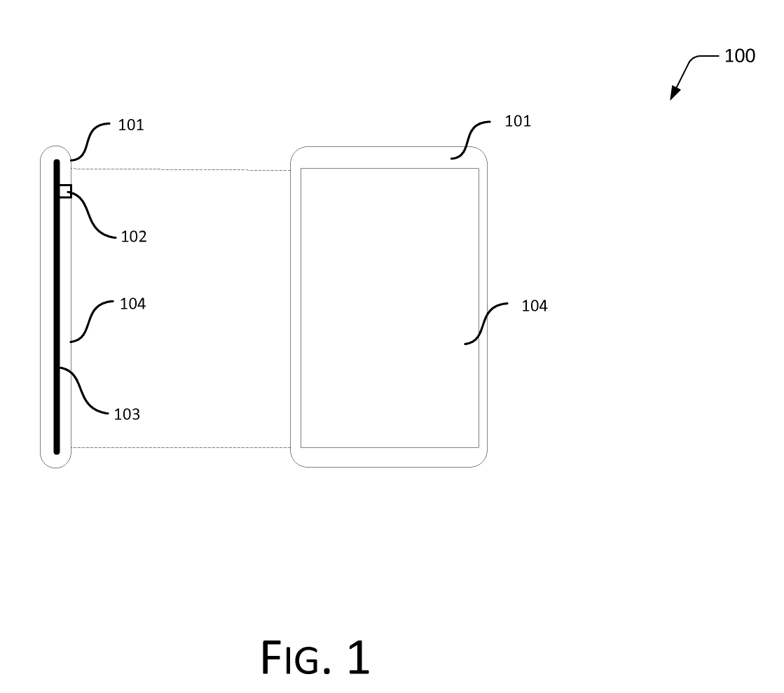

FIG. 1 shows a section view and a front view of a mobile communication terminal 100 provided by a first embodiment of the present disclosure. The mobile communication terminal 100 may include a front panel 101, a bone conduction device 102 and a motherboard 103. The front panel is configured with a display or screen 104.

The bone conduction device 102 is in contact or touch with the screen 104 or the front panel 101, and a contact point of the bone conduction device 102 is connected to the motherboard 103. The bone conduction device 102 receives an electronic signal transmitted from a processor of the motherboard 103 through the contact point, and transmits the electronic signal to the screen 104 or the front panel 101 through a place of contact therebetween to activate vibrations of the screen 104 or the front panel 101.

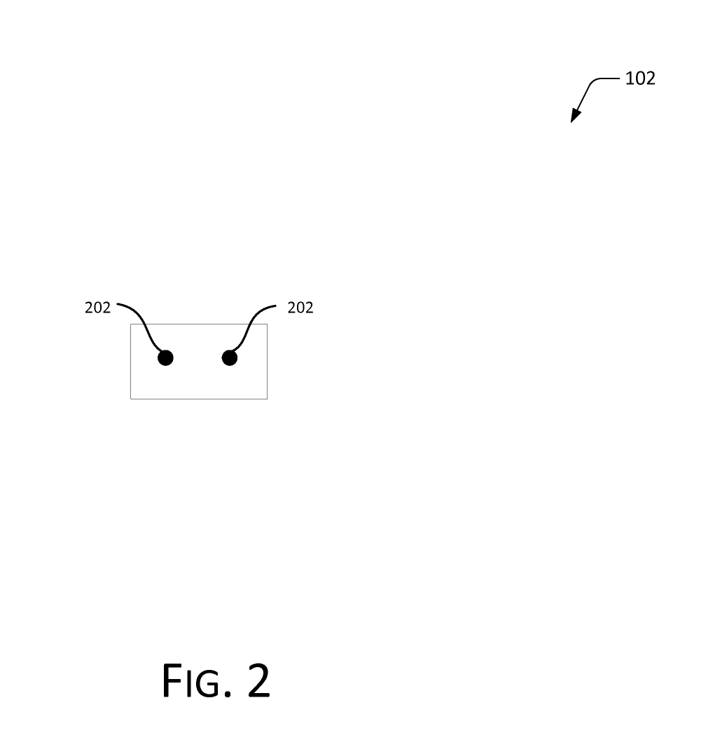

Specifically, the mobile communication terminal 100 may be a phone. FIG. 1 shows the bone conduction device 102 being in touch or contact with the screen 104. Under normal circumstances, the bone conduction device 102 may additionally or alternatively be in touch or contact with the front panel 101. FIG. 2 shows a schematic diagram illustrating a bone conduction device that may be used. The bone conduction device 102 may include two contact points 202. The contact points 202 are connected to the motherboard 103. The bone conduction device 102 receives electronic signal(s) sent from processor(s) of the motherboard 103 via these two contact points 202, and transmits the electronic signal(s) to the screen 104 or the front panel 101 through a place or position of contact with the screen 104 or the front panel 101 to activate or trigger vibrations of the screen 104 or the front panel 101, thus transmitting audio to a user through a contact between the mobile communication terminal and a human ear or a human face.

In an embodiment, the bone conduction device 102 is attached to an internal surface of the screen 104.

In an embodiment, the bone conduction device 102 may be a bone conduction ceramic device, e.g., a bone conduction device made of ceramic material.

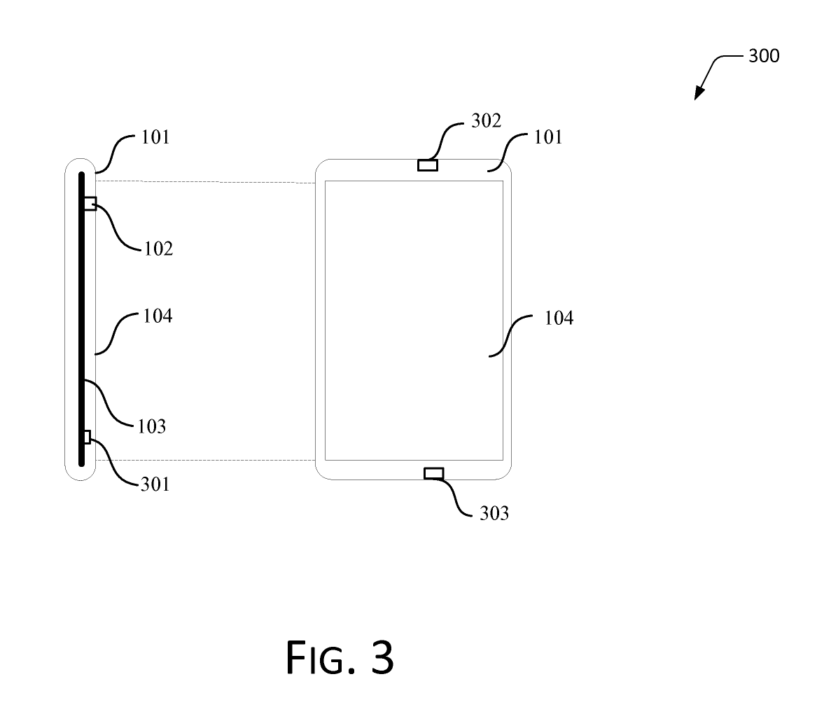

FIG. 3 shows a section view and a front view of a mobile communication terminal 300 provided by a second embodiment of the present disclosure. The mobile communication terminal 300 may include a front panel 101, a bone conduction device 102 and a motherboard 103. The front panel 101 is configured with a screen 104, a gravity sensor 301, a first sound transmitter 302 (or a first microphone), and a second sound transmitter 303 (or a second microphone).

The gravity sensor 301 is deployed or set up in the motherboard 103, and is used for detecting a placement status of the mobile communication terminal 300. The placement status of the mobile communication terminal 300 refers to a placement status of the mobile communication terminal 300 when the user answers a call, which includes an upright position status of and an inverted position status. The upright position status corresponds to a state when the top (or upper) portion of the front panel 101 of the mobile communication terminal 300 is facing up (or at the upper end) and the bottom (or lower) portion of the front panel 101 is facing down (or at the lower end). The inverted position status corresponds to a state when the top portion of the front panel 101 of the mobile communication terminal 300 is facing down (or at the upper end) and the bottom portion of the front panel 101 is facing up (or at the lower end).

The first sound transmitter 302 and the second sound transmitter 303 are transmitters having the same functional(ities). The first sound transmitter 302 is deployed at the top of the front panel 101 and is connected with the motherboard 103. The second first sound transmitter 303 is deployed at the bottom of the front panel 101 and is connected with the motherboard 103.

The processor of the motherboard 103 sets up respective working states of the first sound transmitter 302 and the second sound transmitter 303 based at least in part on the placement status detected by the gravity sensor 301. In an embodiment, in an event that the mobile communication terminal 300 is in an upright position status, the processor transmits a first control signal to the second sound transmitter 303 and a second control signal to the first sound transmitter 302. In another embodiment, in an event that the mobile communication terminal 300 is in an inverted position status, the processor transmits the first control signal to the first sound transmitter 302 and the second control signal to the second sound transmitter 303. The first control signal is used for setting up a corresponding sound transmitter in a working state for transmission of an audio signal, and the second control signal is used for setting up a corresponding sound transmitter in a working state for noise cancellation.

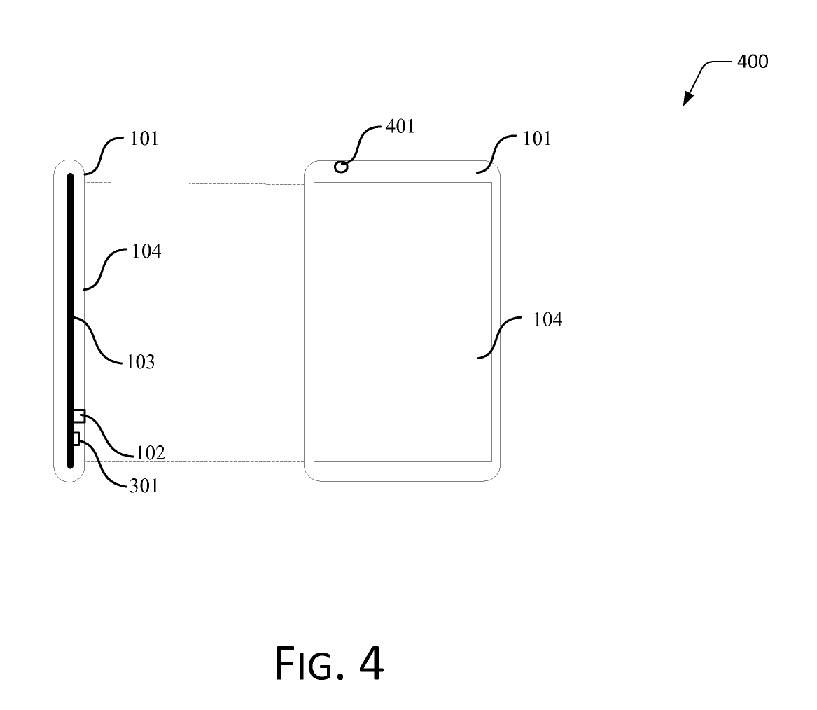

FIG. 4 shows a section view and a front view of a mobile communication terminal 400 provided by a third embodiment of the present disclosure. The mobile communication terminal 400 may include a front panel 101, a bone conduction device 102 and a motherboard 103. The front panel 101 is configured with a screen 104, a receiver 401 (or an earphone) and a gravity sensor 301.

The receiver 401 is deployed at the top of the front panel 101, and is connected with the processor of the motherboard 103 via a first interface. The bone conduction device 102 is deployed at the bottom of the screen 104 or the front panel 101, and is connected with the processor of the motherboard 103 via a second interface. The gravity sensor 301 is used for detecting a placement status of the mobile communication terminal 400.

In an embodiment, the processor of the motherboard 103 transmits an electronic signal to the receiver 401 or the bone conduction device 102 based at least in part on the placement status detected by the gravity sensor 301. In an embodiment, in an event that the mobile communication terminal 400 is in a status of an upright position, the processor transmits the electronic signal to the receiver 401 via the first interface to enable a user to hear a voice of another party through the receiver 401. In another embodiment, in an event that the mobile communication terminal 400 is in a status of an inverted position, the processor transmits the electronic signal to the bone conduction device 102 via the second interface to enable the user to hear the voice of the other party through the bone conduction device 102.

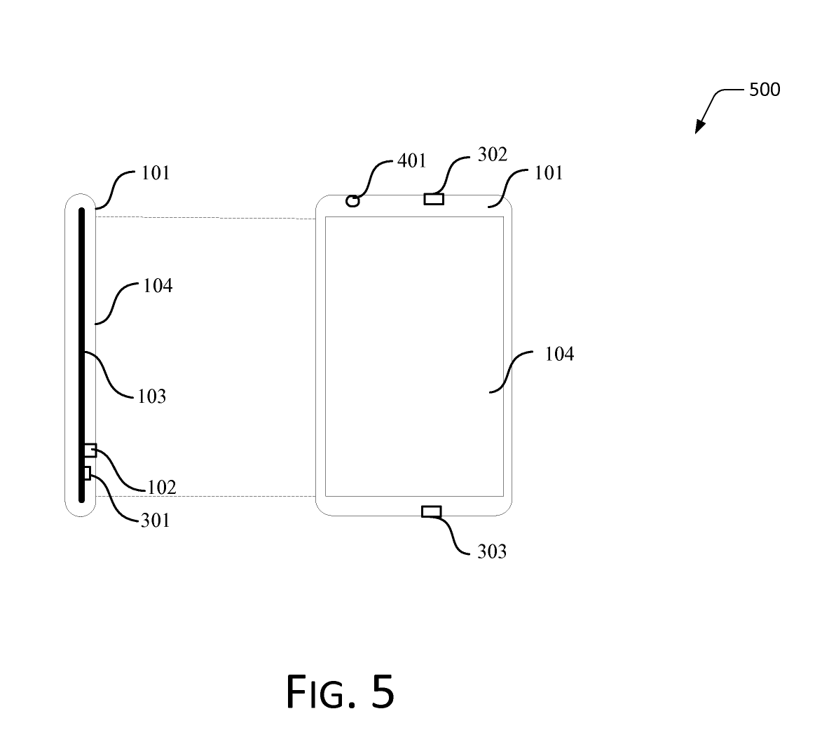

FIG. 5 shows a section view and a front view of a mobile communication terminal 500 provided by a fourth embodiment of the present disclosure. The mobile communication terminal 500 may include a front panel 101, a bone conduction device 102 and a motherboard 103. The front panel 101 is configured with a screen 104, a gravity sensor 301, a first sound transmitter 302 and a second sound transmitter 303.

The first sound transmitter 302 is deployed at the top portion of the front panel 101 and is connected to the motherboard 103. The second sound transmitter 303 is deployed at the bottom portion of the front panel 101 and is connected to the motherboard 103.

The gravity sensor 301 is used for detecting a placement status of the mobile communication terminal 500.

A processor of the motherboard 103 sets up respective working states of the first sound transmitter 302 and the second sound transmitter 303 based at least in part on the placement status detected by the gravity sensor 301. In an embodiment, in an event that the mobile communication terminal 500 is in a status of an upright position, the processor transmits a first control signal to the second sound transmitter 303 and a second control signal to the first sound transmitter 302. Specifically, the second sound transmitter 303 is set up for transmitting an audio signal, and the first sound transmitter 302 is set up for canceling noise. Furthermore, the processor transmits an electronic signal to the receiver 401 via a first interface to enable a user to hear a voice of another party through the receiver 401. Moreover, the receiver 401 and the second sound transmitter 303 operate cooperatively when the user is in a call. In another embodiment, in an event that the mobile communication terminal 500 is in a status of an inverted position, the processor transmits the first control signal to the first sound transmitter 302 and the second control signal to the second sound transmitter 303. In other words, the first sound transmitter 302 is set up for transmission of an audio signal, and the second sound transmitter 303 is set up for noise cancellation. Moreover, the bone conduction device 102 and the first sound transmitter 302 operate cooperatively when the user is in a call. The first control signal is used for setting up a sound transmitter in a working state for transmission of an audio signal, and the second control signal is used for setting up a sound transmitter in a working state for noise cancellation.

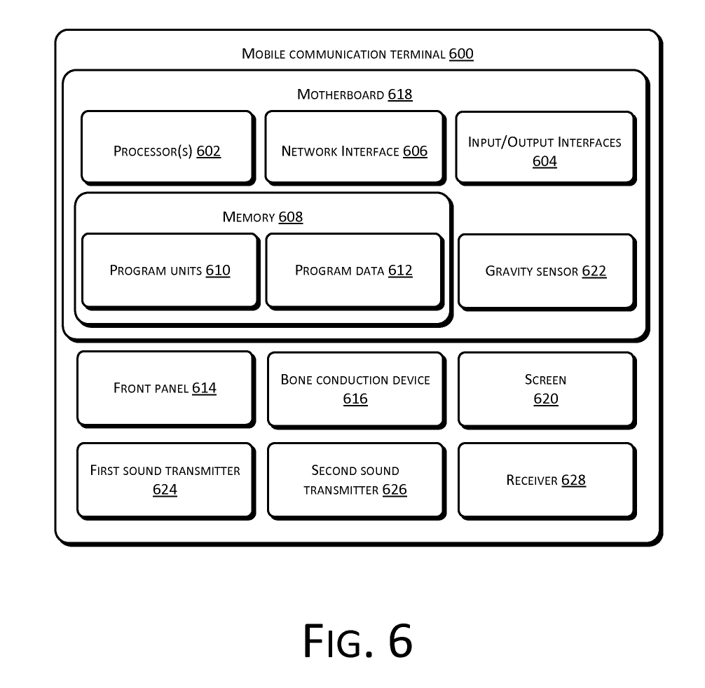

FIG. 6 shows an example mobile communication terminal 600, as described in FIGS. 1 and 3-5, in more detail. In an embodiment, the mobile communication terminal 600 may include one or more processors 602, an input/output interface 604, a network interface 606 and memory 608. The memory 608 may include program units 610 and program data 612.

In an embodiment, the memory 608 may include a form of computer readable media such as volatile memory, Random Access Memory (RAM), and/or non-volatile memory, e.g., Read-Only Memory (ROM) or flash RAM, etc. The memory 608 is an example of a computer readable media.

The computer readable media may include a permanent or non-permanent type, a removable or non-removable media, which may achieve storage of information using any method or technology. The information may include a computer-readable command, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In an embodiment, the mobile communication terminal 600 may further include a front panel 614, a bone conduction device 616, a motherboard 618, a display or screen 620, a gravity sensor 622, a first sound transmitter 624, a second sound transmitter 626 and/or a receiver 628. In an example as shown in FIG. 6, the one or more processors 602, the input/output interface 604, the network interface 606, the memory 608 and the gravity sensor 622 are included in the motherboard 618. In some embodiments, a part and not all of one or more of the one or more processors 602, the input/output interface 604, the network interface 606, the memory 608 and the gravity sensor 622 may be included in the motherboard 618. Details of the above components have been described in the foregoing embodiments, and therefore are not repeatedly described herein.

As can be seen from the foregoing description, the present disclosure provides a mobile communication terminal, which includes: a front panel, a bone conduction device and a motherboard. The front panel is configured with a screen. The bone conduction device is in contact with the screen or the front panel, and a contact point of the bone conduction device is connected with the motherboard. The bone conduction device receives an electronic signal transmitted from a processor of the motherboard through the contact point, and transmits the electronic signal to the screen or the front panel through a place of contact therebetween to activate vibrations of the screen or the front panel, thereby transmitting audio to a user. Since the bone conduction device is used in the present disclosure to replace a receiver for transmitting electronic signals, audio can be transmitted to the user through the bone conduction device in a normal manner regardless of whether the mobile communication terminal is in a status of an upright position or in a status of an inverted position. Therefore, the user can hear the voice of another party clearly, and thus the quality of conversation is improved.

Although the exemplary embodiments of the present disclosure have been described herein, one skilled in the art can make changes and modifications to these embodiments after understanding the fundamental creative concept of the present disclosure. The claims attached herein intend to include the exemplary embodiments and all changes and modifications covered by the embodiments of the present disclosure.

Apparently, one skilled in the art may make various changes and modifications to the embodiments without departing the spirit and scope of the present disclosure. As such, the present disclosure further covers these changes and modifications if the changes and modifications to the present disclosure belong to the claims and their equivalents of the present disclosure.

What is claimed is:

1. A mobile communication terminal comprising:
a front panel configured with a screen;
a motherboard; and
a bone conduction device being in contact with the screen or the front panel, the bone conduction device receiving an electronic signal transmitted from a processor of the motherboard through a contact point, and transmitting the electronic signal to the screen or the front panel to activate vibrations of the screen or the front panel through a place of contact between the bone conduction device and the screen or the front panel.

2. The mobile communication terminal of claim 1, further comprising:
a gravity sensor deployed in the motherboard to detect a placement status of the mobile communication terminal;
a first sound transmitter deployed at a top of the front panel and connected with the motherboard;
a second sound transmitter deployed at a bottom of the front panel and connected with the motherboard.

3. The mobile communication terminal of claim 2, wherein the processor of the motherboard further sets up respective working states of the first sound transmitter and the second sound transmitter based at least in part on the placement status detected by the gravity sensor.

4. The mobile communication terminal of claim 2, wherein the processor further determines that the mobile communication terminal is in an upright position status based at least in part on the placement status detected by the gravity sensor, and transmits a first control signal to the second sound transmitter and a second control signal to the first sound transmitter in response to the determining, the first control signal setting up the second sound transmitter in a working state for transmission of an audio signal and the second control signal setting up the first sound transmitter in a working state for noise cancellation.

5. The mobile communication terminal of claim 2, wherein the processor further determines that the mobile communication terminal is in an inverted position status based at least in part on the placement status detected by the gravity sensor, and transmits a first control signal to the first sound transmitter and a second control signal to the second sound transmitter in response to the determining, the first control signal setting up the first sound transmitter in a working state for transmission of an audio signal and the second control signal setting up the second sound transmitter in a working state for noise cancellation.

6. The mobile communication terminal of claim 1, further comprising:
a receiver deployed at a top of the front panel, and connected with the processor of the motherboard via a first interface; and
a gravity sensor deployed in the motherboard to detect a placement status of the mobile communication terminal, wherein the bone conduction device is deployed at a bottom of the screen or the front panel, and is connected with the processor of the motherboard via a second interface, and the processor further transmits the electronic signal to the receiver or the bone conduction device based at least in part on the placement status detected by the gravity sensor.

7. The mobile communication terminal of claim 6, wherein the processor transmits the electronic signal to the receiver via the first interface in an event that the mobile communication terminal is in an upright position status.

8. The mobile communication terminal of claim 6, wherein the processor transmits the electronic signal to the bone conduction device via the second interface in an event that the mobile communication terminal is in an inverted position status.

9. The mobile communication terminal of claim 6, further comprising: a first sound transmitter and a second sound transmitter, the first sound transmitter being deployed at the top portion of the front panel and connected with the motherboard; and the second first sound transmitter being deployed at a bottom portion of the front panel and connected with the motherboard.

10. The mobile communication terminal of claim 9, wherein the processor of the motherboard further sets up respective working states of the first sound transmitter and the second sound transmitter based at least in part on the placement status detected by the gravity sensor.

11. The mobile communication terminal of claim 10, wherein the processor transmits a first control signal to the second sound transmitter and a second control signal to the first sound transmitter in an event that the mobile communication terminal is in an upright position status, the first control signal setting up the second sound transmitter in a working state for transmission of an audio signal and the second control signal setting up the first sound transmitter in a working state for noise cancellation.

12. The mobile communication terminal of claim 10, wherein the processor transmits the first control signal to the first sound transmitter and the second control signal to the second sound transmitter in an event that the mobile communication terminal is in an inverted position status, the first control signal setting up the first sound transmitter in a working state for transmission of an audio signal and the second control signal setting up the second sound transmitter in a working state for noise cancellation.

13. The mobile communication terminal of claim 1, wherein the bone conduction device is attached to an internal surface of the screen.

14. The mobile communication terminal of claim 1, wherein the bone conduction device comprises a bone conduction ceramic device.

15. A mobile communication terminal comprising:
a front panel configured with a screen;
a motherboard; and
a gravity sensor to detect a placement status of the mobile communication terminal;
a receiver deployed at a top of the front panel and connected with a processor of the motherboard via a first interface; and
a bone conduction device deployed at a bottom of the screen or the front panel and connected with the processor of the motherboard via a second interface, wherein the processor transmits an electronic signal to the receiver or the bone conduction device based at least in part on a placement status detected by the gravity sensor.

16. The mobile communication terminal of claim 15, wherein the processor transmits the electronic signal to the receiver via the first interface to enable a user to hear a voice of another party in a call through the receiver in an event that the mobile communication terminal is in an upright position status to cause

17. The mobile communication terminal of claim 15, wherein the processor transmits the electronic signal to the bone conduction device via the second interface to enable a user to hear a voice of another party in a call through the bone conduction device in an event that the mobile communication terminal is in an inverted position status.

18. The mobile communication terminal of claim 17, wherein the bone conduction device receives the electronic signal from the processor of the motherboard through a contact point, and transmits the electronic signal to the screen or the front panel to activate vibrations of the screen or the front panel through a place of contact between the bone conduction device and the screen or the front panel.

19. The mobile communication terminal of claim 17, wherein the bone conduction device is attached to an internal surface of the screen.

20. A mobile communication terminal comprising:
a front panel configured with a screen;
a motherboard;
a gravity sensor to detect a placement status of the mobile communication terminal; and
a bone conduction device to:
receive an electronic signal from a processor of the motherboard through a contact point,
transmit the electronic signal to the screen or the front panel to activate vibrations of the screen or the front panel through a place of contact between the bone conduction device and the screen or the front panel, and
enable a user to hear a voice of another party in a call from the bone conduction device in an event that the mobile communication terminal is in an inverted position status detected by the gravity sensor.
